(19) United States
(12) Patent Application Publication
(10) Pub. No.: US 2023/0417857 A1
(43) Pub. Date: Dec. 28, 2023

(54) VEHICLE ULTRASONIC SENSOR DETECTION

(71) Applicant: Ford Global Technologies, LLC, Dearborn, MI (US)

(72) Inventors: Rajiv Sithiravel, Scarborough (CA); Sutharsan Sivagnanam, Windsor (CA); Douglas James McEwan, Saline, MI (US); David A. LaPorte, Livonia, MI (US)

(73) Assignee: Ford Global Technologies, LLC, Dearborn, MI (US)

(21) Appl. No.: 17/746,143

(22) Filed: May 17, 2022

(51) Int. Cl. G01S 3/808; G01S 15/931; G01S 15/04; G01S 15/87; G01S 15/10

(52) U.S. Cl. CPC G01S 3/808; G01S 15/931; G01S 15/10; G01S 15/876; G01S 15/04

(57) ABSTRACT

A computer includes a processor and a memory, and the memory stores instructions executable to receive range data from a plurality of ultrasonic sensors on a vehicle, determine two ellipses from respective pulses of the range datadetermine a plurality of intersections of the two ellipses, exclude a subset of the intersections, and actuate a component of the vehicle based on the nonexcluded intersections. The ultrasonic sensors have respective fields of view, the fields of view overlap, and the range data includes distances traveled by pulses emitted by the ultrasonic sensors and received by the ultrasonic sensors. Each pulse is emitted by a different one of the ultrasonic sensors than received that pulse. Excluding the subset of the intersections is based on the fields of view.

### BACKGROUND

Vehicles are typically equipped with a plurality of sensors. The sensors may detect the external world, e.g., objects and/or characteristics of surroundings of the vehicle, such as other vehicles, road lane markings, traffic lights and/or signs, pedestrians, etc. One type of sensor that can be included in a vehicle is an ultrasonic sensor. Ultrasonic sensors measure distances to features of the environment by emitting ultrasonic sound waves and converting the reflected sound into an electrical signal.

### BRIEF DESCRIPTION OF THE DRAWINGS

FIG. 1 is a block diagram of an example vehicle.

FIG. 2 is a top view of a portion of the vehicle with ultrasonic sensors.

FIG. 3 is a diagrammatic top view of the portion of the vehicle with fields of view of the ultrasonic sensors.

FIG. 4 is a diagrammatic top view of the portion of the vehicle with an ellipse defined by data from the ultrasonic sensors.

FIG. 5 is a diagrammatic top view of the portion of the vehicle with an intersection between an ellipse and an arc of circle defined by data from the ultrasonic sensors.

FIG. 6 is a diagrammatic top view of the portion of the vehicle with intersections between two ellipses defined by data from the ultrasonic sensors.

FIG. 7 is a process flow diagram of an example process for actuating a component of the vehicle based on data from the ultrasonic sensors.

### DETAILED DESCRIPTION

This disclosure provides techniques for providing increased accuracy for data from ultrasonic sensors. A vehicle can include the ultrasonic sensors, which have overlapping fields of view. A computer onboard the vehicle can receive range data from the ultrasonic sensors. The range data includes distances traveled by pulses emitted and received by the ultrasonic sensors. The computer can determine two ellipses from two pulses that are each emitted by a different ultrasonic sensor than received the pulse. The computer can determine a plurality of intersections of the ellipses, exclude a subset based on the fields of view of the ultrasonic sensors, and actuate a component of the vehicle based on the nonexcluded intersections. The programming of the computer provides a computationally efficient way to locate objects detected by the ultrasonic sensors in a highly accurate manner. The vehicle can then be actuated to avoid the objects.

A computer includes a processor and a memory, and the memory stores instructions executable to receive range data from a plurality of ultrasonic sensors on a vehicle, determine a first ellipse from a first pulse of the range data, determine a second ellipse from a second pulse of the range data, determine a plurality of intersections of the first ellipse and the second ellipse, exclude a subset of the intersections, and actuate a component of the vehicle based on the nonexcluded intersections. The ultrasonic sensors have respective fields of view, the fields of view overlap, and the range data include distances traveled by pulses emitted by the ultrasonic sensors and received by the ultrasonic sensors. The first pulse is emitted by a different one of the ultrasonic sensors than received the first pulse. The second pulse is emitted by a different one of the ultrasonic sensors than received the second pulse. Excluding the subset of the intersections is based on the fields of view.

Excluding the subset of the intersections may include excluding the intersections that are outside of the fields of view of the ultrasonic sensors that emitted and that received the first pulse and the second pulse. Excluding the subset of the intersections may include excluding the intersections that are outside of any one of the fields of view of the ultrasonic sensors that emitted or that received the first pulse or the second pulse.

The ultrasonic sensor that emitted the first pulse and the ultrasonic sensor that received the first pulse may be focal points of the first ellipse, and the ultrasonic sensor that emitted the second pulse and the ultrasonic sensor that received the second pulse may be focal points of the second ellipse. A sum of the distances from each focal point of the first ellipse to points on the first ellipse may be determined from a range distance of the first pulse, and a sum of the distances from each focal point of the second ellipse to points on the second ellipse may be determined from a range distance of the first pulse.

The instructions may further include instructions to determine a point at a center of the field of view of a first ultrasonic sensor of the ultrasonic sensors at a distance determined from a third pulse emitted from and received by the first ultrasonic sensor, and actuating the component may be based on the point. The instructions may further include instructions to fuse the point and the nonexcluded intersections, and actuating the component may be based on the fusion of the point and the nonexcluded intersections.

The instructions may further include instructions to exclude the plurality of the intersections based on the fields of view and, upon excluding the plurality of the intersections, actuate the component based on the point and not based on the intersections.

The instructions may further include instructions to determine an arc of circle from a third pulse of the range data, the third pulse emitted from and received by a first ultrasonic sensor of the ultrasonic sensors, and actuating the component may be based on the arc of circle. The intersections may be first intersections, the instructions may further include instructions to determine a second intersection of the arc of circle and the first ellipse, and actuating the component may be based on the second intersection. The instructions may further include instructions to fuse the nonexcluded first intersections and the second intersection, and actuating the component may be based on the fusion of the nonexcluded first intersections and the second intersection.

The intersections may be first intersections, the arc of circle may be a first arc of circle, the instructions further include instructions to determine a second arc of circle from a fourth pulse of the range data, the fourth pulse emitted from and received by a second ultrasonic sensor of the ultrasonic sensors, and determine a second intersection of the first arc of circle and the second arc of circle, and actuating the component may be based on the second intersection.

The arc of circle may be contained within the field of view of the first ultrasonic sensor.

A radius of the arc of circle may be based on a range distance of the third pulse.

The instructions may further include instructions to, upon determining that the range data includes a single pulse, actuate the component based on the single pulse. The single pulse may be emitted from and received by a first ultrasonic sensor of the ultrasonic sensors, and the instructions may further include instructions to determine a point at a center of the field of view of the first ultrasonic sensor at a distance determined from a third pulse, and actuate the component based on the point and not based on the intersections.

The single pulse may be emitted from a first ultrasonic sensor of the ultrasonic sensors and received by a second ultrasonic sensor of the ultrasonic sensors, and the instructions may further include instructions to determine a point equidistant from the first ultrasonic sensor and second ultrasonic sensor, and actuate the component based on the point and not based on the intersections.

Actuating the component may include actuating the component to avoid the vehicle crossing the nonexcluded intersections.

The component may include a brake system.

A method includes receiving range data from a plurality of ultrasonic sensors on a vehicle, determining a first ellipse from a first pulse of the range data, determining a second ellipse from a second pulse of the range data, determining a plurality of intersections of the first ellipse and the second ellipse, excluding a subset of the intersections, and actuating a component of the vehicle based on the nonexcluded intersections. The ultrasonic sensors have respective fields of view, the fields of view overlap, and the range data include distances traveled by pulses emitted by the ultrasonic sensors and received by the ultrasonic sensors. The first pulse is emitted by a different one of the ultrasonic sensors than received the first pulse. The second pulse is emitted by a different one of the ultrasonic sensors than received the second pulse. Excluding the subset of the intersections is based on the fields of view.

With reference to the Figures, wherein like numerals indicate like parts throughout the several views, a computer 105 includes a processor and a memory, and the memory stores instructions executable to receive range data from a plurality of ultrasonic sensors 110 on a vehicle 100, determine a first ellipse 405 from a first pulse of the range data, determine a second ellipse 405 from a second pulse of the range data, determine a plurality of intersections 310 of the first ellipse 405 and the second ellipse 405, exclude a subset of the intersections 310, and actuate a component of the vehicle 100 based on the nonexcluded intersections 310. The ultrasonic sensors 110 have respective fields of view, the fields of view overlap, and the range data include distances traveled by pulses emitted by the ultrasonic sensors 110 and received by the ultrasonic sensors 110. The first pulse is emitted by a different one of the ultrasonic sensors 110 than received the first pulse. The second pulse is emitted by a different one of the ultrasonic sensors 110 than received the second pulse. Excluding the subset of the intersections 310 is based on the fields of view.

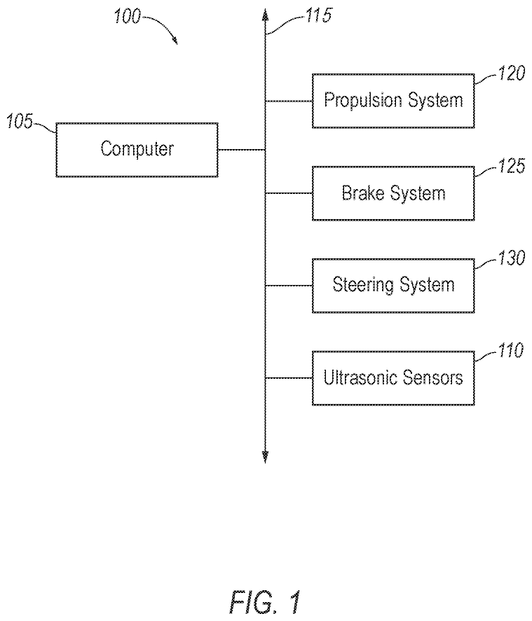

With reference to FIG. 1, the vehicle 100 may be any passenger or commercial automobile such as a car, a truck, a sport utility vehicle, a crossover, a van, a minivan, a taxi, a bus, etc.

The computer 105 is a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The computer 105 can thus include a processor, a memory, etc. The memory of the computer 105 can include media for storing instructions executable by the processor as well as for electronically storing data and/or databases, and/or the computer 105 can include structures such as the foregoing by which programming is provided. The computer 105 can be multiple computers 105 coupled together.

The computer 105 may transmit and receive data through a communications network 115 such as a controller area network (CAN) bus, Ethernet, WiFi, Local Interconnect Network (LIN), onboard diagnostics connector (OBD-II), and/or by any other wired or wireless communications network. The computer 105 may be communicatively coupled to a propulsion system 120, a brake system 125, a steering system 130, the ultrasonic sensors 110, and other components via the communications network 115.

The propulsion system 120 of the vehicle 100 generates energy and translates the energy into motion of the vehicle 100. The propulsion system 120 may be a conventional vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion system 120 can include an electronic control unit (ECU) or the like that is in communication with and receives input from the computer 105 and/or a human operator. The human operator may control the propulsion system 120 via, e.g., an accelerator pedal and/or a gear-shift lever.

The brake system 125 is typically a conventional vehicle braking subsystem and resists the motion of the vehicle 100 to thereby slow and/or stop the vehicle 100. The brake system 125 may include friction brakes such as disc brakes, drum brakes, band brakes, etc.; regenerative brakes; any other suitable type of brakes; or a combination. The brake system 125 can include an electronic control unit (ECU) or the like that is in communication with and receives input from the computer 105 and/or a human operator. The human operator may control the brake system 125 via, e.g., a brake pedal.

The steering system 130 is typically a conventional vehicle steering subsystem and controls the turning of the wheels. The steering system 130 may be a rack-and-pinion system with electric power-assisted steering, a steer-by-wire system, as both are known, or any other suitable system. The steering system 130 can include an electronic control unit (ECU) or the like that is in communication with and receives input from the computer 105 and/or a human operator. The human operator may control the steering system 130 via, e.g., a steering wheel.

The ultrasonic sensors 110 measure distances to features of the environment by emitting pulses formed of ultrasonic sound waves and converting the reflected pulses into electrical signals. Each pulse can contain one or more characteristics, e.g., frequency, from which the ultrasonic sensor 110 that emitted the pulse can be identified and the time at which the pulse was emitted can be identified. A pulse may be received by the same or a different ultrasonic sensor 110 than emitted the pulse.

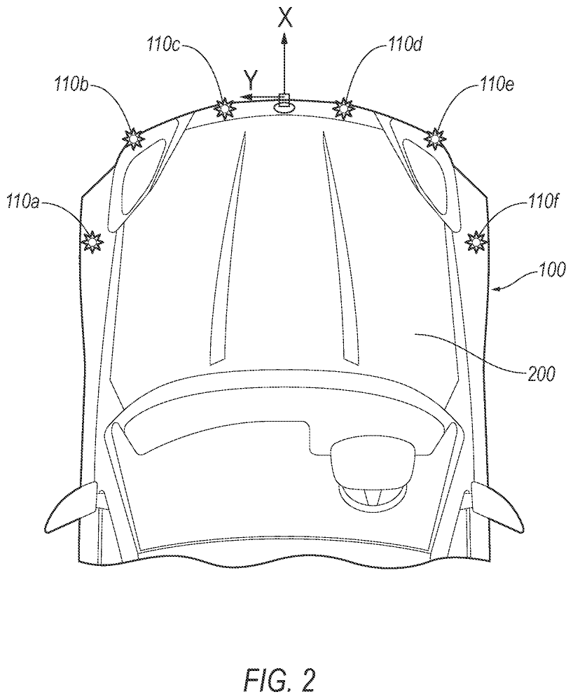

With reference to FIG. 2, the ultrasonic sensors 110 can be mounted on a body 200 of the vehicle 100 and fixed relative to the body 200 of the vehicle 100. For example, the ultrasonic sensors 110 can be arrayed laterally across a front end of the vehicle 100. The vehicle 100 can include a plurality of the ultrasonic sensors 110, e.g., six. The ultrasonic sensors 110 can include, in order from a left side of the vehicle 100 to a right side, a first ultrasonic sensor 110a, a second ultrasonic sensor 110b, a third ultrasonic sensor 110c, a fourth ultrasonic sensor 110d, a fifth ultrasonic sensor 110e, and a sixth ultrasonic sensor 110f.

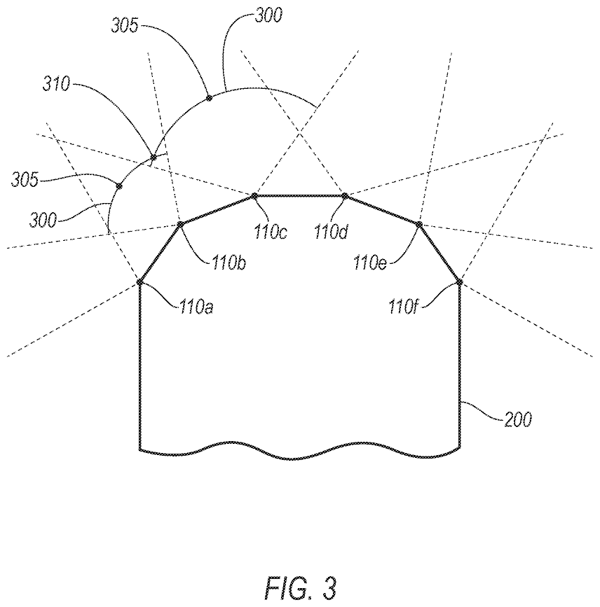

With reference to FIG. 3, the ultrasonic sensors 110 have respective fields of view. Each field of view is a solid angle extending from the respective ultrasonic sensor 110. The fields of view can have comparatively wide horizontal angles and narrow vertical angles. The fields of view are overlapping. For example, the field of view of each ultrasonic sensor 110 can overlap at least the fields of view of the adjacent ultrasonic sensors 110, e.g., the field of view of the second ultrasonic sensor 110b can overlap the fields of view of the first and third ultrasonic sensors 110a,c. The overlapping fields of view mean that a pulse emitted by one ultrasonic sensor 110 can be received by a different ultrasonic sensor 110.

The ultrasonic sensors 110 generate range data, which is received by the computer 105. The range data includes distances traveled by the pulses. Each distance is a combined distance from the emitting ultrasonic sensor 110 to a feature of the environment, and from the feature of the environment to the receiving ultrasonic sensor 110. Because the pulses travel at a known, constant speed, the distances can be determined by the differences between respective emission times and reception times.

For a pulse emitted from and received by the same ultrasonic sensor 110 of the ultrasonic sensors 110, the computer 105 can be programmed to determine a center point 305 at a center of the field of view of that ultrasonic sensor 110 at a distance determined from that third pulse. The center of the field of view means that a horizontal angle from the center to one edge of the field of view is equal to a horizontal angle from the center to the other edge of the field of view; i.e., the center of the field of view is at a halfway point across the field of view. For example, FIG. 3 shows center points 305 determined for the second ultrasonic sensor 110b and for the third ultrasonic sensor 110c. The center points 305 can be represented as, e.g., coordinates in a local coordinate system fixed relative to the vehicle 100. For example, the coordinate system can be a Cartesian coordinate system with an origin at a fixed location on the vehicle 100 such as the center of the rear axle, an X-axis directed longitudinally forward relative to the vehicle 100, and a Y-axis directed laterally leftward relative to the vehicle 100. The center point 305 can be one estimate of a location of an object in the environment.

For a pulse emitted from and received by the same ultrasonic sensor 110 of the ultrasonic sensors 110, the computer 105 can be programmed to determine an arc of circle 300. The radius of the arc of circle 300 can be based on a range distance of the pulse. The circle can be represented according to the following formula:

(x−x₁)²+(y−y₁)²=r²

in which (x₁, y₁) are the coordinates of the ultrasonic sensor 110 and r is half the range distance traveled by the pulse from and back to the ultrasonic sensor 110. The arc of circle 300 can be contained within the field of view of the ultrasonic sensor 110, e.g., the arc of circle 300 can extend from one edge of the field of view to the other edge of the field of view.

The computer 105 can be programmed to determine an intersection 310 of two arcs of circle 300. The arcs of circle 300 can be determined from respective pulses as described above. For example, the computer 105 can solve for the two-dimensional coordinates of the intersection 310 using two equations, one representing each circle. The result will be two, one, or zero intersections 310. In the cases of one or zero intersections 310, the computer 105 determines a failure to find an intersection 310. In the case of two intersections 310, the computer 105 can then exclude the intersections 310 that are not on both of the arcs of circle 300, i.e., that are outside of at least one of the fields of view of the ultrasonic sensors 110 from which arcs of circle 300 were determined, e.g., the fields of view of the second and third ultrasonic sensors 110b,c in the example of FIG. 3. At least one of the two intersections 310 will be excluded. If both intersections 310 are excluded, the computer 105 determines a failure to find an intersection 310. If one intersection 310 is excluded, the nonexcluded intersection 310 is used. The nonexcluded intersection 310 can be one estimate of a location of an object in the environment.

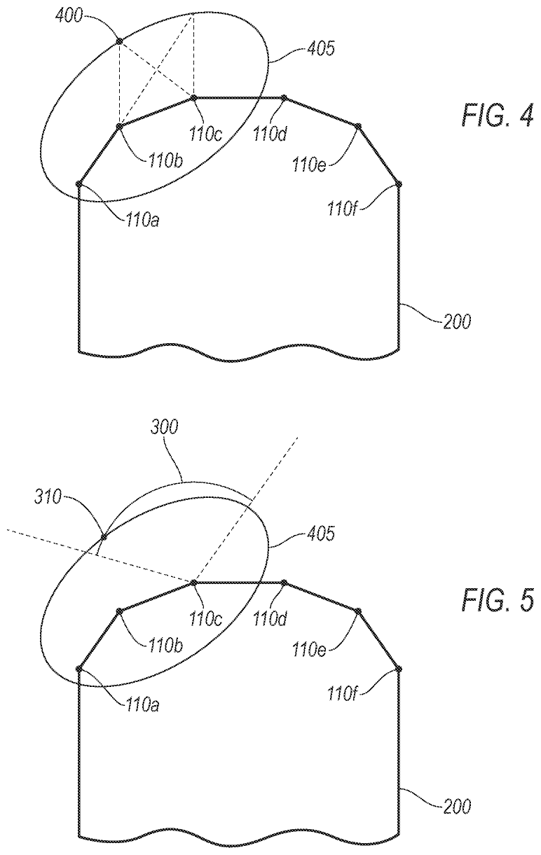

With reference to FIG. 4, for a pulse emitted by a different one of the ultrasonic sensors 110 than received the pulse, the computer 105 can be programmed to determine an equidistant point 400 that is equidistant from the two ultrasonic sensors 110, i.e., the distance from the emitting ultrasonic sensor 110 to the equidistant point 400 is the same as the distance from the receiving ultrasonic sensor 110 to the equidistant point 400. For example, the computer 105 can solve for the two-dimensional coordinates of the equidistant point 400 by using at least two equations. The equations can be derived geometrically from the known coordinates of the two ultrasonic sensors 110 and the distance from the sensors to the equidistant point 400 being equal. The equidistant point 400 can be one estimate of a location of an object in the environment.

For a pulse emitted by a different one of the ultrasonic sensors 110 than received the pulse, the computer 105 can be programmed to determine an ellipse 405. An ellipse 405 is a regular oval shape, traced by a point moving in a plane so that the sum of its distances from two focal points is constant. In this case, the ultrasonic sensor 110 that emitted the first pulse and the ultrasonic sensor 110 that received the first pulse are the focal points of the ellipse 405, and the sum of the distances from each focal point of the ellipse 405 to any point on the ellipse 405 are determined from a range distance of the pulse, e.g., the distance from the pulse is the sum of the distances from the focal points. This information fully defines the ellipse 405, and the computer 105 can determine a formula representing the ellipse 405 according to known geometry of ellipses 405. For example, the ellipse 405 can be represented by the following formula:

Ax²+Bxy+Cy²+Dx+Ey+F=0

in which the parameters A through F are defined as follows:

$$A = \frac{{cos}^{2} φ}{{a}^{2}} + \frac{{sin}^{2} φ}{{b}^{2}} \\ B = \frac{2 sin φcos φ}{{a}^{2}} - \frac{2 sin φcos φ}{{b}^{2}} \\ C = \frac{{sin}^{2} φ}{{a}^{2}} + \frac{{cos}^{2} φ}{{b}^{2}} \\ D = - \frac{2 cos φ ( {x}_{1} cos φ + {y}_{1} sin φ )}{{a}^{2}} + \frac{2 sin φ ( {y}_{1} cos φ - {x}_{1} sin φ )}{{b}^{2}} \\ E = - \frac{2 sin φ ( {x}_{1} cos φ + {y}_{1} sin φ )}{{a}^{2}} + \frac{2 cos φ ( {x}_{1} sin φ - {y}_{1} cos φ )}{{b}^{2}} \\ F = \frac{{( {x}_{1} cos φ + {y}_{1} sin φ )}^{2}}{{a}^{2}} + \frac{{( {x}_{1} sin φ - {y}_{1} cos φ )}^{2}}{{b}^{2}} - 1$$

in which φ is the rotation of the ellipse, a is one of the major or minor axis, b is the other of the major or minor axis, and (x₁, y₁) are the coordinates halfway between the emitting and receiving ultrasonic sensor 110.

With reference to FIG. 5, the computer 105 can be programmed to determine an intersection 310 of an arc of circle 300 and an ellipse 405. The arc of circle 300 and the ellipse 405 can be determined from respective pulses as described above. For example, the computer 105 can solve for the two-dimensional coordinates of the intersection 310 using two equations, one representing the circle and the other representing the ellipse 405. The result will be from zero to four intersections 310. In the case of zero intersections 310, the computer 105 determines a failure to find an intersection 310. Otherwise, the computer 105 can then exclude the intersections 310 that are not on the arc of circle 300, i.e., that are outside of the field of view of the ultrasonic sensor 110 from which the arc of circle 300 was determined, e.g., the field of view of the third ultrasonic sensor 110c in the example of FIG. 5. Excluding the intersections 310 not on the arc of circle 300 will leave zero or one intersection 310 (or rarely two). If all the intersections 310 are excluded, the computer 105 determines a failure to find an intersection 310. Otherwise, the nonexcluded intersection 310 is used. (If two intersections 310 are nonexcluded, the computer 105 can use a point halfway between the intersections 310.) The nonexcluded intersection 310 can be one estimate of a location of an object in the environment.

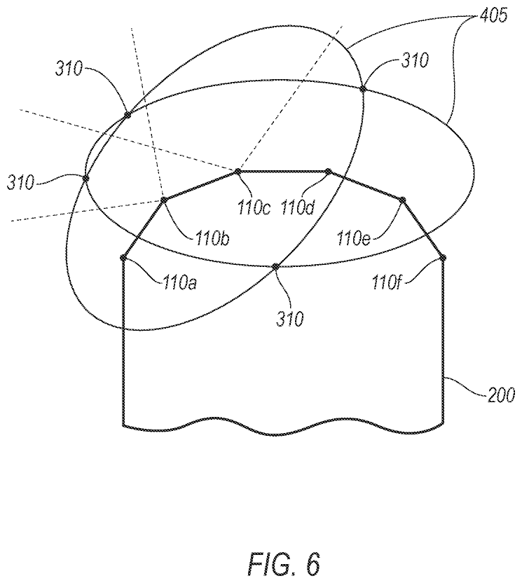

With reference to FIG. 6, the computer 105 can be programmed to determine a plurality of intersections 310 of two ellipses 405. The ellipses 405 can be determined from respective pulses as described above. The computer 105 can solve for the two-dimensional coordinates of the intersections 310 using two equations, one representing each ellipse 405. For example, the computer 105 can use numerical approximation. For another example, the computer 105 can set the Bezout determinant of one variable of the coordinates, e.g., x, equal to zero, resulting in a quartic polynomial in the other variable of the coordinates, e.g., y. The roots of the quartic polynomial in y can be substituted into the original ellipse 405 equations to get corresponding values for x. The result will be from zero to four intersections 310. In the case of zero intersections 310, the computer 105 determines a failure to find an intersection 310.

The computer 105 can be programmed to exclude a subset of the intersections 310 based on the fields of view. For example, the computer 105 can exclude the intersections 310 that are outside of the fields of view of the ultrasonic sensors 110 that emitted and that received the two pulses from which the ellipses 405 were determined. The computer 105 can exclude the intersections 310 that are outside of any one of the fields of view of the ultrasonic sensors 110 that emitted or that received the two pulses.

The computer 105 can be programmed to fuse two or more of the center point 305, the equidistant point 400, and/or the nonexcluded intersections 310 of the arcs of circle 300 and/or ellipses 405 (referred to collectively as the points 305, 310, 400). The fusion can be performed with one or more algorithms, e.g., clustering, Kalman filter, central limit theorem, Bayesian networks, Dempster-Shafer, convolutional neural networks, etc. The computer 105 can perform an algorithm for clustering the points, e.g., k-means, density-based spatial clustering (DBSCAN), Gaussian mixture model, affinity propagation, ordering points to identify the clustering structure (OPTICS), etc. Then the computer 105 can determine a metric for each cluster, e.g., a centroid or an arithmetical average of the points 305, 310, 400 in each cluster.

The computer 105 can be programmed to actuate a component of the vehicle 100 based on the points 305, 310, 400, i.e., the center points 305, the equidistant points 400, and/or the nonexcluded intersections 310 of the arcs of circle 300 and/or ellipses 405. The component of the vehicle 100 can include, e.g., the brake system 125 and/or the steering system 130. The actuation is based on whichever of the points 305, 310, 400 are available to the computer 105. For example, if the range data includes a single pulse, the computer 105 can actuate the component based on the single pulse, e.g., based on the center point 305 or equidistant point 400 determined from the single pulse. For another example, if the determination of intersections 310 described above results in all the intersections 310 being excluded, meaning there are no nonexcluded intersections 310, the computer 105 can actuate the component based on the center point 305 and/or the equidistant point 400, if available, and not based on the intersections 310. For another example, if multiple points 305, 310, 400 are available and fused as described immediately above, the computer 105 can actuate the component based on the fusion of the points 305, 310, 400.

The computer 105 can be programmed to actuate the component to avoid the vehicle 100 crossing the points 305, 310, 400, i.e., the center points 305, the equidistant points 400, and/or the nonexcluded intersections 310 of the arcs of circle 300 and/or ellipses 405. For example, if the points 305, 310, 400 are in front of the vehicle 100, the computer 105 can actuate the brake system 125 to stop the vehicle 100 from moving forward into the points 305, 310, 400. For another example, the computer 105 can actuate the steering system 130 to swerve the vehicle 100 to avoid the points 305, 310, 400.

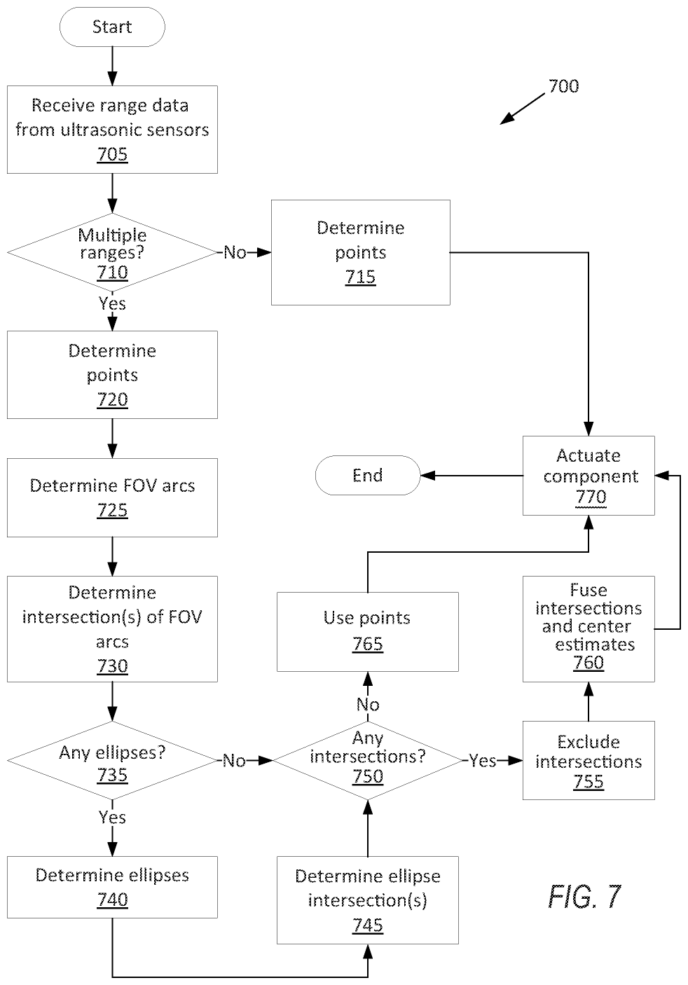

FIG. 7 is a process flow diagram illustrating an exemplary process 700 for actuating the component of the vehicle 100 based on data from the ultrasonic sensors 110. The memory of the computer 105 stores executable instructions for performing the steps of the process 700 and/or programming can be implemented in structures such as mentioned above. As a general overview of the process 700, the computer 105 receives the range data from the ultrasonic sensors 110. If the range data includes a single range, the computer 105 determines the center point 305 or equidistant point 400 and actuates the component based on the center point 305 or equidistant point 400. If the range data includes multiple ranges, the computer 105 determines the center points 305 and equidistant points 400, determines the arcs of circle 300 and the intersections 310 of arcs of circle 300, determines the ellipses 405 if any and intersections 310 with ellipses 405. If there are intersections 310, the computer 105 excludes a subset of the intersections 310 based on the fields of view, fuses the points 305, 310, 400, and actuates the component. If there are not intersections 310, the computer 105 actuates the component based on the center points 305 and equidistant points 400.

The process 700 begins in a block 705, in which the computer 105 receives the range data from the ultrasonic sensors 110.

Next, in a block 710, the computer 105 determines whether the range data includes multiple ranges, i.e., multiple distinct pulses. If so, the process 700 proceeds to a block 720. If not, the process 700 proceeds to a block 715.

In the block 715, the computer 105 determines the center point 305 or equidistant point 400 from the single pulse, as described above. After the block 715, the process 700 proceeds to a block 770.

In the block 720, the computer 105 determines the center points 305 and/or equidistant points 400, as describe above.

Next, in a block 725, the computer 105 determines the arcs of circle 300, as described above.

Next, in a block 730, the computer 105 determines the intersections 310 of the arcs of circle 300, if any.

Next, in a decision block 735, the computer 105 determines whether there are any ellipses 405 to determine, i.e., whether any of the pulses were received by a different ultrasonic sensor 110 than emitted the pulse. If so, the process 700 proceeds to a block 740. If not, the process 700 proceeds to a decision block 750.

In the block 740, the computer 105 determines the ellipses 405, as described above.

Next, in a block 745, the computer 105 determines the intersections 310 between ellipses 405 and/or between ellipses 405 and arcs of circle 300, as described above. After the block 745, the process 700 proceeds to the decision block 750.

In the decision block 750, the computer 105 determines whether the computer 105 successfully determined any intersections 310 in the blocks 730 and 745. If so, the process 700 proceeds to a block 755. If not, the process 700 proceeds to a block 765.

In the block 755, the computer 105 excludes the subset of the intersections 310 based on the fields of view, as described above.

Next, in a block 760, the computer 105 fuses the points 305, 310, 400, as described above. After the block 760, the process 700 proceeds to the block 770.

In the block 765, the computer 105 determines to use the center points 305 and/or equidistant points 400 from the block 720 for actuating the vehicle 100. After the block 765, the process 700 proceeds to the block 770.

In the block 770, the computer 105 actuates the component of the vehicle 100 based on the points 305, 310, 400, as described above. After the block 770, the process 700 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Python, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a nonrelational database (NoSQL), a graph database (GDB), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. The adjectives “first” and “second” are used throughout this document as identifiers and are not intended to signify importance, order, or quantity. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A computer comprising a processor and a memory, the memory storing instructions executable to:
receive range data from a plurality of ultrasonic sensors on a vehicle, the ultrasonic sensors having respective fields of view, the fields of view overlapping, the range data including distances traveled by pulses emitted by the ultrasonic sensors and received by the ultrasonic sensors;
determine a first ellipse from a first pulse of the range data, the first pulse emitted by a different one of the ultrasonic sensors than received the first pulse;
determine a second ellipse from a second pulse of the range data, the second pulse emitted by a different one of the ultrasonic sensors than received the second pulse;
determine a plurality of intersections of the first ellipse and the second ellipse;
exclude a subset of the intersections based on the fields of view;
identify a point for which a horizontal angle from one edge of the field of view of a first ultrasonic sensor of the ultrasonic sensors to the point is equal to a horizontal angle from the other edge of the field of view to the point and which is located at a distance determined from a third pulse emitted from and received by the first ultrasonic sensor;
fuse the point and the nonexcluded intersections by executing a sensor fusion algorithm taking the point and the nonexcluded intersections as inputs representing independent estimates of a location of an object; and
actuate a component of the vehicle based on the fusion of the point and the nonexcluded intersections.

2. The computer of claim 1, wherein excluding the subset of the intersections includes excluding the intersections that are outside of the fields of view of the ultrasonic sensors that emitted and that received the first pulse and the second pulse.

3. The computer of claim 2, wherein excluding the subset of the intersections includes excluding the intersections that are outside of any one of the fields of view of the ultrasonic sensors that emitted or that received the first pulse or the second pulse.

4. The computer of claim 1, wherein the ultrasonic sensor that emitted the first pulse and the ultrasonic sensor that received the first pulse are focal points of the first ellipse, and the ultrasonic sensor that emitted the second pulse and the ultrasonic sensor that received the second pulse are focal points of the second ellipse.

5. The computer of claim 4, wherein a sum of the distances from each focal point of the first ellipse to points on the first ellipse are determined from a range distance of the first pulse, and a sum of the distances from each focal point of the second ellipse to points on the second ellipse are determined from a range distance of the first pulse.

6. (canceled)

7. (canceled)

8. The computer of claim 1, wherein the instructions further include instructions to:
exclude the plurality of the intersections based on the fields of view; and
upon excluding the plurality of the intersections, actuate the component based on the point and not based on the intersections.

9. The computer of claim 1, wherein
the instructions further include instructions to determine an arc of circle from a third pulse of the range data, the third pulse emitted from and received by a second ultrasonic sensor of the ultrasonic sensors; and
actuating the component is based on the arc of circle.

10. The computer of claim 9, wherein
the intersections are first intersections;
the instructions further include instructions to determine a second intersection of the arc of circle and the first ellipse; and
actuating the component is based on the second intersection.

11. The computer of claim 10, wherein
the instructions further include instructions to fuse the nonexcluded first intersections and the second intersection by executing the sensor fusion algorithm taking the nonexcluded first intersections and the second intersections as inputs representing independent estimates of the location of the object; and
actuating the component is based on the fusion of the nonexcluded first intersections and the second intersection.

12. The computer of claim 9, wherein the intersections are first intersections, the arc of circle is a first arc of circle, and the instructions further include instructions to:
determine a second arc of circle from a fourth pulse of the range data, the fourth pulse emitted from and received by a second ultrasonic sensor of the ultrasonic sensors; and
determine a second intersection of the first arc of circle and the second arc of circle, wherein actuating the component is based on the second intersection.

13. The computer of claim 9, wherein the arc of circle is contained within the field of view of the second ultrasonic sensor.

14. The computer of claim 9, wherein a radius of the arc of circle is based on a range distance of the third pulse.

15. The computer of claim 1, wherein the instructions further include instructions to:
receive second range data from the ultrasonic sensors;
upon determining that the second range data includes a single pulse, actuate the component based on the single pulse.

16. The computer of claim 15, wherein
the single pulse is emitted from and received by a second ultrasonic sensor of the ultrasonic sensors; and
the instructions further include instructions to identify a second point for which a horizontal angle from one edge of the field of view of the second ultrasonic sensor to the second point is equal to a horizontal angle from the other edge of the field of view to the second point and which is located at a distance determined from a third the single pulse, and actuate the component based on the position of the second point and not based on the intersections.

17. The computer of claim 15, wherein
the single pulse is emitted from a second ultrasonic sensor of the ultrasonic sensors and received by a second ultrasonic sensor of the ultrasonic sensors; and
the instructions further include instructions to identify a second point that is equidistant from the second ultrasonic sensor and second ultrasonic sensor at a distance from the first and second ultrasonic sensors determined from the single pulse, and actuate the component based on the position of the second point and not based on the intersections.

18. The computer of claim 1, wherein actuating the component includes actuating the component to avoid the vehicle crossing the nonexcluded intersections.

19. The computer of claim 1, wherein the component includes a brake system.

20. A method comprising:
receiving range data from a plurality of ultrasonic sensors on a vehicle, the ultrasonic sensors having respective fields of view, the fields of view overlapping, the range data including distances traveled by pulses emitted by the ultrasonic sensors and received by the ultrasonic sensors;
determining a first ellipse from a first pulse of the range data, the first pulse emitted by a different one of the ultrasonic sensors than received the first pulse;
determining a second ellipse from a second pulse of the range data, the second pulse emitted by a different one of the ultrasonic sensors than received the second pulse;
determining a plurality of intersections of the first ellipse and the second ellipse;
excluding a subset of the intersections based on the fields of view;
identifying a point for which a horizontal angle from one edge of the field of view of a first ultrasonic sensor of the ultrasonic sensors to the point is equal to a horizontal angle from the other edge of the field of view to the point and which is located at a distance determined from a third pulse emitted from and received by the first ultrasonic sensor;
fusing the point and the nonexcluded intersections by executing a sensor fusion algorithm taking the point and the nonexcluded intersections as inputs representing independent estimates of a location of an object; and
actuating a component of the vehicle based on the nonexcluded intersections.
